(19) United States
(12) Patent Application Publication
(10) Pub. No.: US 2004/0035858 A1
(43) Pub. Date: Feb. 26, 2004

(54) Device for reheating by microwaves

(76) Inventors: Hendrikus Bauke De Boer, Vlaardingen (NL); Peter Moret, Ewloe (GB); Dirk Johan Out, Vlaardingen (NL); Leon Marie Spierts, Maastricht (NL)

Correspondence Address: UNILEVER, PATENT DEPARTMENT, 45 RIVER ROAD, EDGEWATER, NJ, 07020, US

(21) Appl. No.: 10/432,271

(22) PCT Filed: Oct. 4, 2001
(86) PCT No.: PCT/EP01/11432

(30) Foreign Application Priority Data
Nov. 14, 2000 (EP) 00204009.5

(51) Int. Cl. H05B 6/64

(52) U.S. Cl. 219/679

(57) ABSTRACT

The invention concerns a novel device for reheating microwaveable food products and comprises (i) an external container (1) composed of a lower part (2) and a removable lid (3) fitting to the lower part (2), all being made of a heat resistant mineral composition that is transparent for microwaves. (ii) a sheet (6) susceptible to microwave heating, which sheet (6) is positioned above the bottom (8) of container (1) and spaced from the bottom (8) by supports (9) creating a heat insulating interspace (4a) between the bottom (8) and the sheet (6), (iii) in the top of the device just below lid (3) but separated therefrom a sheet (11) susceptible to microwave heating.

Nowadays food products, including snacks and baked bakery products become more and more popular as components of the daily meal. These products are made in a form that makes them readily available for the consumer and all the consumer needs to do is to reheat the food product prior to consumption. This reheating should be achievable in the shortest time possible. For this microwave techniques are available these days, however microwave reheating is not always so easy and easily results in products that are overheated, in particular locally overheated so that local burned spots are present in or on the food products after the reheating. Also the crispness of the products obtained by these known techniques is not always the crispness that is desired. Therefore these products are not appreciated by the consumers and consequently we have studied whether we could find a solution for this so that we can make reheated food products in a short time using microwave energy but which products do not display the disadvantages of the products made by the known techniques. Moreover we studied whether we could make a device that is reusable and that does not need to be discarded after use as is the case for known devices (e.g. such as known from U.S. Pat. No. 4,190,757). Moreover our device should be removable from the oven without giving problems because of the high temperature of the device (about 280° C.) leaving the MW-oven. We also studied whether we could improve the heating efficiency of the device and of the microwave heating.

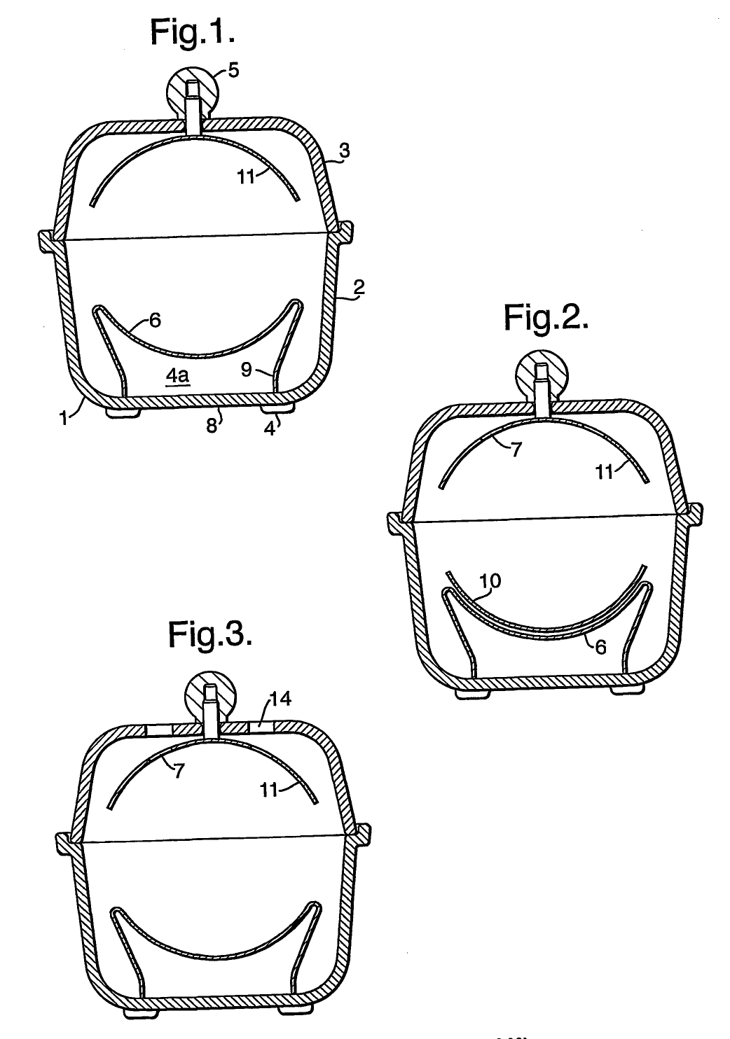

The devices according to the invention are represented schematically in FIG. 1-6 to which we will refer further in this patent application. However this does not mean that our invention is limited to the devices represented in these FIGS. 1-6, other devices are also possible within the broad scope of our invention that are not represented in these FIG. 1-6.

The above study has resulted in our new invention and therefore this invention concerns in the first instance a device for microwave reheating of food products, in particular of snacks or baked bakery products comprising;

(i) an external container (1) composed of a lower part (2) and a removable lid (3) fitting to the lower part (2), all being made of a heat resistant mineral composition that is transparent for microwaves

(ii) the lower part (2) optionally being provided with support means (4) and

(iii) optionally the lid (3) being provided with heat insulated grips (5) for removal of the hot lid (3) from the lower part (2) of the container (1)

(iv) a sheet (6 ) susceptible to microwave heating which sheet (6) is positioned above the bottom (8) of container (1) and spaced from the bottom (8) by supports (9) creating a heat insulating interspace (4a) between the bottom (8) and the sheet (6)

(v) optionally a container (10) for the food product to be heated by microwave heating and made from a material not transparent for microwaves, which container is in direct heat exchange contact with sheet (6) and

(vi) in the top of the device just below lid (3) but separated therefrom a sheet (11) susceptible to microwave heating.

The construction of the external container with a lower part (2) and a removable lid (3) makes it easy to put the food product that must be reheated in the container and to remove it therefrom after reheating is completed. The fact that the container is made from a material that is transparent to microwaves (i.e. most of the microwaves will pass through thin material and only small amounts here of will be absorpted by this material) makes it possible that the microwaves can penetrate the container and can be used for the reheating in the way as described below.

The support means (4), although not imperative have two advantages i.e. 1. the bottom of the container (1) which may be very hot after reheating and which may after removal from the oven burn any support (e.g. a table) it will placed upon will not contact this support so that this support will not be burned and 2. the microwaves entering the container can be used in a more efficient way to heat the susceptor material present in the container because now also microwaves coming from below the bottom (8) or reflected within the MW-oven can be used herefore.

The heat insulated grips (5) makes it easier to remove the hot lid (3) after reheating is finished, however we are not limited to devices with such a grip; a device without such a grip also will result in reheated baked bakery products of very good quality. Similar grips can be present on the lower part (2) for easier handling of the device.

The position of sheet (6), which is a sheet made of or containing a material susceptible to microwave heating is crucial for the heating efficiency and the quality of the products resulting therefrom. This sheet (6) is positioned above bottom (8) and spaced therefrom by support means (9) in order to create an interspace (4a) between bottom and susceptor (6). This interspace will form a heat barrier between the bottom (8) and the susceptor (6) and therefore will help to prevent that the bottom will be overheated. Simultaneously this interspace will make it possible that the microwaves penetrating the oven will be used in an efficient way. This construction is much simpler than the construction disclosed in U.S. Pat. No. 4,663,506, wherein the ferrite layer (18) is separated from bottom (52) by suspending container (12) by shelf (78).

The presence of a removable container (10) for the food products that must be reheated is not imperative because these food products can also immediately be put on the susceptor sheet (6). However, the container (10) is useful to avoid that the whole device has to be cleaned after every time it is used (with the container 10 only this container can be cleaned). This internal container, if present is not provided with a layer of material susceptable to microwave heating as is the case in the device, disclosed in U.S. Pat. No. 4,663,506 (cf. ferrite layer (20) on container (12)).

Essential for obtaining the desired product quality after reheating is that in the top of the device, just below lid (3) a second susceptor material (11) is present , here in the form of a sheet. This sheet (11) should not be in direct contact with lid (3) as this will avoid that lid (3) will become very hot i.e. will reach temperatures of 250 to 300° C.

The material from which the susceptors (6) and (11) can be made can be selected from any material known to be highly susceptible to microwave heating with the prerequisite that the materials are food allowable. A convenient material is the product resulting from the heating of a metal powder and a mineral clay (as a support herefore and providing physical strength after baking of the clay) and wherein this metal powder is incorporated. Aluminium powder is preferably used herefore.

The susceptor material sheets (6) respectively (11) are according to another embodiment of our invention suitably made from a metal sheet provided with a coating of a material susceptible to microwave heating at that surface of the sheets (6) respectively (11) facing the container (1) respectively the lid (3), the coating in particular being a ferrite containing material. The heat developed by the susceptors (6) and (11) is transferred to the metal sheet by conduction and the heat produced by these sheets is used to reheat the food products.

Beneficial results are obtained when sheet (6) and/or sheet (11) is/are provided at the side facing the container (1) respectively the lid (3) with a layer of material that forms a heat barrier, this material not being susceptible to microwave heating. These barrier materials give a more efficient use of the heat produced because less of the heat will be lost from the system.

It was further found that a very efficient reheating could be achieved when, in case the container (10) is present, the sheets (6) and/or (11) is/are made of a metal and is/are provided with holes (7) forming a pattern for a faster microwave heating of the food product in container (10). The holes can help to focus the microwave energy in those parts of the food product to be reheated where this is desired.

In the instance wherein container (10) is absent we found that the best quality reheated products could be obtained if sheets (6) and/or (11) and/or container (10) has/have a shape following the contour of the product to be reheated. In this way a more homogeneous heating of the product to be reheated is possible.

By using a material that can reflect infrared waves at either the innerside of lid (3) or at the innerside of bottom (8) it can be prevented that heat losses occur while simultaneously the temperature of the container and/or the lid do not become too high. This results in a better quality of the products. Such materials are well known and any of these materials that is a food allowable material can be used in our device.

A further improvement can be achieved by using a black coating on the side of sheet (11) or of sheet (6) facing the product in the device, this coating will improve the radiation efficiency of these sheets and results in a better crispness after reheating.

During the reheating water vapour will be formed and it is suitable to remove this water vapour in a controlled way. This can be achieved by providing holes (14) in the container (1) in particular in its lid (3).

The materials from which the device of the invention is made are such that the device is reusable for a great number of times. This has ecological and economical advantages.

Examples of food products that can be reheated with our novel device are: baked bakery products on basis of a bread dough, such as breadrolls; filled bread rolls (wherein the filling can be a sweet or savoury filling), but also snack products, such as prefried or precooked snacks, snacks provided with a coating e.g. on basis of bread crumbs (such as croquettes or bitterballen, or fishfingers), wrapped food products, such as tortilla's or springrolls, wherein the wrapper can be a pancake, a ceral such as a maize based wrapper or an omelette can be reheated in this device. Other examples of food products that can be reheated are crude puff pastries (resulting in cooked puffed pastries) and raw meat products, such as raw chicken or raw pork. The new device can also be used for cooking au gratin of food products, containing cheese, such as onion soup or warm meals.

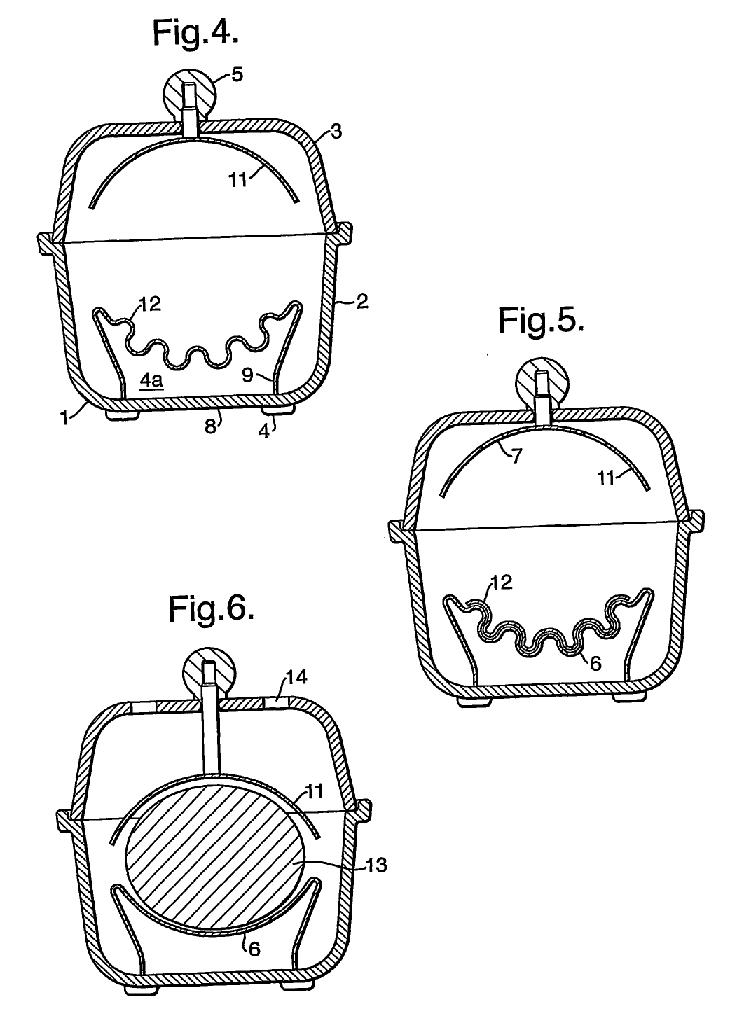

Although in all those instances the device illustrated in FIG. 1-3 can be used we found that a further improvement could be obtained by using a device as illustrated in FIG. 4-6. According to these embodiments can sheet (6) and/or container (10) be provided with premoulded shapes (12) (e.g. in the form of round troughs or dips or as corrugations) matching with the size and the shape of the food product to be reheated. These troughs or corrugations will fixate the food product in the device during reheating, so that a more homogeneous reheating is possible.

A very convenient device for above purposes is the device illustrated in FIG. 6, wherein food product (13) is in contact with both sheet (6) and with sheet (11), which latter sheet is further away from lid (3) than in the device according to FIG. 1-3. In this instance it is also possible to use a container (10) that completely encompasses food products (13) and thus is in touch with both sheet (6) and with sheet (11).

1. Device for microwave reheating of food products comprising;
(i) an external container (1) composed of a lower part (2) and a removable lid (3) fitting to the lower part (2), all being made of a heat resistant mineral composition that is transparent for microwaves
(ii) the lower part (2) optionally being provided with support means (4) and
(iii) optionally the lid (3) being provided with heat insulated grips (5) for removal of the hot lid (3) from the lower part (2) of the container (1)
(iv) a sheet (6) susceptible to microwave heating, which sheet (6) is positioned above the bottom (8) of container (1) and spaced from the bottom (8) by supports (9) creating a heat insulating interspace (4a) between the bottom (8) and the sheet (6)
(v) optionally a container (10) for the food product to be heated by microwave heating and made from a material not transparent for microwaves, which container is in direct heat exchange contact with sheet (6)
(vi) in the top of the device just below lid (3) but separated therefrom a sheet (11) susceptible to microwave heating.

2. Device according to claim 1, wherein the sheets (6) respectively (11) is/are made of a material that in combination with a mineral composition upon heating gives a material susceptible to microwave heating, in particular a metal powder, such as aluminium, in combination with a mineral clay.

3. Device according to claim 1 wherein the sheets (6) respectively (11) is/are made from a metal sheet provided with a coating of a material susceptible to microwave heating at that surface of the sheets (6) respectively (11) facing the container (1) respectively the lid (3), the coating in particular being a ferrite containing material.

4. Device according to claims 2 or 3, wherein sheet (6) and/or sheet (11) is/are provided at the side facing the container (1) respectively the lid (3) with a layer of material that forms a heat barrier.

5. Device according to claim 1, wherein the container (10) is present, while the sheets (6) and/or (11) is/are made of a metal and is/are provided with holes (7) forming a pattern for a faster microwave heating of the food product in container (10).

6. Device according to claim 1 wherein the container (10) is absent while the sheet (6) has a shape following the contour of the product to be reheated in the device.

7. Device according to claim 1 , wherein the lid (3) is provided at its innerside with a material reflecting IR.

8. Device according to claim 1, wherein sheet (11) at the side facing the product in the device is provided with a black coating to improve the radiation efficiency of sheet (11) and to increase the crispness of the product after microwave reheating.

9. Device according to claim 1 wherein the bottom (8) of container (1) is provided at its innerside with a coating of a material reflecting IR.

10. Device according to claim 1 wherein the external container (1), in particular its lid (3) is provided with holes (14) to remove the water vapour formed during the reheating of the baked bakery products.

11. Device according to any of claims 1 to 10, wherein the materials from which the device is made are chosen such that the device is reusable.

12. Device according to any of claims 1 to 11, wherein sheet (6) and/or container (10) are provided with premoulded shapes (12), such as troughs or dips or corrugations that match with the shape and size of the food product to be reheated.

13. Device according to any of claims 1-12, wherein sheet (11) is present close to sheet (6) and in heat exchange contact with food product (13).

14. Process for the reheating or cooking of food products by microwaves, wherein the foodproduct is a prefried or precooked snack, a snack provided with a coating, a wrapped food product, a crude puff pastry, raw meat or a food product containing cheese and wherein the food product is reheated using a device according to any of claims 1-13.
